(19) United States
(12) Patent Application Publication
(10) Pub. No.: US 2017/0215266 A1
(43) Pub. Date: Jul. 27, 2017

(54) VIBRATOR UNIT AND TARGET SUPPLY DEVICE

(71) Applicant: Gigaphoton Inc., Tochigi (JP)

(72) Inventors: Toshiyuki HIRASHITA, Oyama-shi (JP); Fumio IWAMOTO, Oyama-shi (JP); Tsukasa HORI, Oyama-shi (JP); Masaki NAKANO, Oyama-shi (JP)

(73) Assignee: Gigaphoton Inc., Tochigi (JP)

(21) Appl. No.: 15/480,454

(22) Filed: Apr. 6, 2017

Related U.S. Application Data
(63) Continuation of application No. PCT/JP2015/081084, filed on Nov. 4, 2015.

(30) Foreign Application Priority Data
Nov. 7, 2014 (JP) PCT/JP2014/079625

(51) Int. Cl. H05G 2/00

(52) U.S. Cl. CPC H05G 2/006; H05G 2/008

(57) ABSTRACT

A vibrator unit may be configured to apply vibration to a target material supplied to an inside of a target flow path. The vibrator unit may include a vibration transmission member to be brought into contact with a first member including the target flow path therein, and a piezoelectric member to be brought into contact with the vibration transmission member. The piezoelectric member may be configured to vibrate in response to an electric signal from the outside. The vibration dumping rate of the vibration transmission member may be smaller than the vibration dumping rate of the first member.

### CROSS-REFERENCE TO RELATED APPLICATIONS

The present application is a continuation application of International Application No. PCT/JP2015/081084 filed on Nov. 4, 2015 claiming the priority to International Application No. PCT/JP2014/079625 filed on Nov. 7, 2014. The contents of the applications are incorporated herein by reference in its entirety.

### BACKGROUND

1. Technical Field

The present disclosure relates to a vibrator unit irradiated with a laser beam for generating extreme ultraviolet (EUV) light, and a target supply device.

2. Related Art

Along with microfabrication of a semiconductor process in recent years, microfabrication of a transfer pattern in the photolithography of the semiconductor process has been progressing rapidly. In the next generation, micromachining of 70 nm to 45 nm, and further, micromachining of 32 nm or less will be required. In response to a requirement of micromachining of 32 nm or less, it is expected to develop an exposure device in which a device for generating extreme ultraviolet (EUV) light having a wavelength of about 13 nm and reduced projection reflective optics are combined.

As EUV light generation apparatuses, three types of apparatuses have been proposed, namely an LPP (Laser Produced Plasma) type apparatus using plasma generated by radiating a laser beam to a target material, a DPP (Discharge Produced Plasma) type apparatus using plasma generated by discharging, and an SR (Synchrotron Radiation) type apparatus using orbital radiation.

### CITATION LIST

### Patent Literature

Patent Literature 1: Japanese Patent Application Laid-Open No. 2010-182555

Patent Literature 2: Japanese Patent Application Laid-Open No. 2013-168221

Patent Literature 3: Japanese National Publication of International Patent Application No. 2014-517980

Patent Literature 4: Japanese Patent Application Laid-Open No. 2008-221187

Patent Literature 5: US Patent Application Publication No. 2014/0042343

### SUMMARY

A vibrator unit according to one aspect of the present disclosure may be configured to apply vibration to a target material supplied to an inside of a target flow path. The vibrator unit may include a vibration transmission member and a piezoelectric member. The vibration transmission member may be brought into contact with a first member including the target flow path therein. The piezoelectric member may be brought into contact with the vibration transmission member. The piezoelectric member may be configured to vibrate in response to an electric signal from the outside. The vibration dumping rate of the vibration transmission member may be smaller than the vibration dumping rate of the first member.

Further, a target supply device according to another aspect of the present disclosure may include a first member and a vibrator unit. The first member may include a target flow path therein. The vibrator unit may include a vibration transmission member configured to be brought into contact with the first member, and a piezoelectric member configured to be brought into contact with the vibration transmission member. The piezoelectric member may be configured to vibrate in response to an electric signal from the outside. The vibration dumping rate of the vibration transmission member may be smaller than the vibration dumping rate of the first member.

### BRIEF DESCRIPTION OF THE DRAWINGS

Some embodiments of the present disclosure will be described below as mere examples with reference to the accompanying drawings.

FIG. 1 schematically illustrates a configuration of an exemplary LPP type EUV light generation system;

FIG. 2 is a schematic diagram illustrating an example of a target supply device including a target supply unit illustrated in FIG. 1;

FIG. 3 illustrates a schematic configuration of a nozzle member, a nozzle holder, and a vibrator unit illustrated in FIG. 2, when seen from below;

FIG. 4 is a perspective view of an exemplary vibrator unit illustrated in FIG. 2;

FIG. 5 is a horizontal cross-sectional view of the vibrator unit illustrated in FIG. 4;

FIG. 6 is a vertical cross-sectional view of the vibrator unit illustrated in FIG. 4;

FIG. 7 is a horizontal cross-sectional view illustrating an exemplary schematic configuration of a vibrator unit according to a first embodiment;

FIG. 8 is a horizontal cross-sectional view illustrating an exemplary schematic configuration of a vibrator unit according to a second embodiment;

FIG. 9 is a horizontal cross-sectional view illustrating an exemplary mounting of a vibrator unit according to a third embodiment;

FIG. 10 is a vertical cross-sectional view of the exemplary mounting illustrated in FIG. 9;

FIG. 11 is a table of exemplary materials selectable as a material of a vibration transmission member in the third embodiment;

FIG. 12 is a cross-sectional view illustrating a schematic shape of a vibrator pin according to a first modification of a vibrator pin;

FIG. 13 is a cross-sectional view illustrating a schematic shape of a vibrator pin according to a second modification of a vibrator pin;

FIG. 14 is a cross-sectional view illustrating a schematic shape of a vibrator pin according to a third modification of a vibrator pin;

FIG. 15 is a cross-sectional view illustrating a schematic shape of a vibrator pin according to a fourth modification of a vibrator pin;

FIG. 16 is a cross-sectional view illustrating a schematic shape according to a first modification of a contact form between a vibrator pin and a vibrator hole;

FIG. 17 is a cross-sectional view illustrating a schematic shape according to a second modification of a contact form between a vibrator pin and a vibrator hole;

FIG. 18 is a cross-sectional view illustrating a schematic shape according to a third modification of a contact form between a vibrator pin and a vibrator hole;

FIG. 19 is a cross-sectional view illustrating a schematic shape according to a fourth modification of a contact form between a vibrator pin and a vibrator hole;

FIG. 20 is a horizontal cross-sectional view illustrating an exemplary schematic configuration of a vibrator unit according to a fourth embodiment;

FIG. 21 is a horizontal cross-sectional view illustrating an exemplary mounting of a vibrator unit according to a fifth embodiment; and

FIG. 22 is a vertical cross-sectional view of the exemplary mounting illustrated in FIG. 21.

### DESCRIPTION OF EMBODIMENTS

Contents
1. Overview
2. Overall description of extreme ultraviolet light generation apparatus

2.1 Configuration

2.2 Operation
3. Terms
4. Target supply device including vibrator unit

4.1 Configuration

4.2 Operation
5. Vibrator unit: Comparative example

5.1 Configuration

5.2 Operation

5.3 Problem
6. Vibrator unit: First embodiment

6.1 Configuration

6.2 Operation

6.3 Effect
7. Vibrator unit: Second embodiment

7.1 Configuration

7.2 Operation

7.3 Effect
8. Vibrator unit: Third embodiment

8.1 Configuration

8.2 Operation

8.3 Effect
9. Modifications of vibrator pin

9.1 First modification

9.2 Second modification

9.3 Third modification

9.4 Fourth modification

9.5 Effects of modifications
10. Modifications of contact form between vibrator pin and vibrator hole

10.1 First modification

10.2 Second modification

10.3 Effect of first and second modifications

10.4 Third modification

10.5 Fourth modification

10.6 Effect of third and fourth modifications
11. Vibrator unit: Fourth embodiment

11.1 Configuration

11.2 Operation

11.3 Effect
12. Vibrator unit: Fifth embodiment

12.1 Configuration

12.2 Operation

12.3 Effect

Hereinafter, embodiments of the present disclosure will be described in detail with reference to the drawings. The embodiments described below illustrate some examples of the present disclosure, without limiting the contents of the present disclosure. Further, the entire configurations and operations described in the respective embodiments may not be indispensable as the configurations and the operations of the present disclosure. It should be noted that the same constituent elements are denoted by the same reference numerals and the description thereof is not repeated herein.

1. Overview Embodiments of the present disclosure may relate to a vibrator unit to be used in a target supply device for supplying a target material for generating EUV light in a droplet form, a target supply device provided with it, and an EUV light generation apparatus. More specifically, embodiments may relate to a vibrator unit configured to apply, to the nozzle tip, vibration for changing a target material ejected from a nozzle in a jet form into a droplet form, a target supply device provided with it, and an EUV light generation apparatus. However, the present disclosure is not limited to these items. The present disclosure may relate to any items for changing liquid ejected in a jet form into a droplet form.

2. Overall Description of EUV Light Generation System

2.1 Configuration

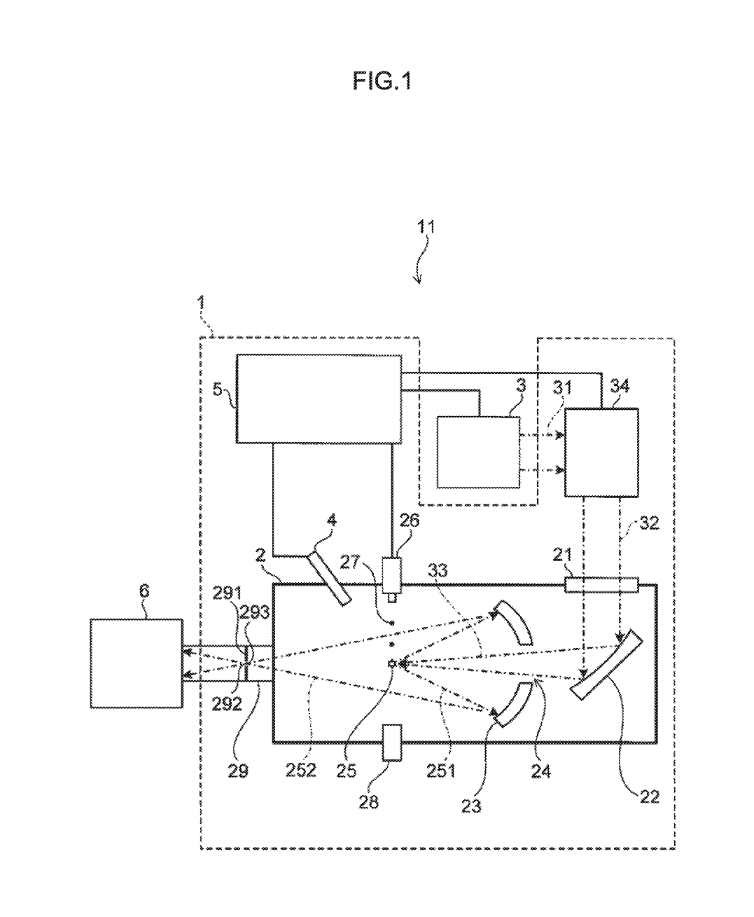

FIG. 1 schematically illustrates a configuration of an exemplary LPP type EUV light generation system. An EUV light generation apparatus 1 may be used together with at least one laser device 3. In the present disclosure, a system including the EUV light generation apparatus 1 and the laser device 3 is referred to as an EUV light generation system 11. As illustrated in FIG. 1 and described below in detail, the EUV light generation apparatus 1 may include a chamber 2 and a target supply unit 26. The chamber 2 may be sealable. The target supply unit 26 may be provided so as to penetrate a wall of the chamber 2. A target material supplied from the target supply unit 26 may include, but not limited to, tin, terbium, gadolinium, lithium, xenon, or a combination of any two or more of them.

The chamber 2 may have at least one through hole in the wall. The through hole may be provided with a window 21, and the window 21 may transmit a pulse laser beam 32 emitted from the laser device 3. In the chamber 2, for example, an EUV focusing mirror 23 having a spheroidal reflecting surface may be arranged. The EUV focusing mirror 23 may have a first focal point and a second focal point. The surface of the EUV focusing mirror 23 may be provided with a multilayer reflective film in which molybdenum and silicon are laminated alternately, for example. It is preferable that the EUV focusing mirror 23 is arranged such that the first focal point locates at a plasma generation region 25 and the second focal point locates at an intermediate focusing point (IF) 292, for example. The EUV focusing mirror 23 may have a through hole 24 in the center portion thereof, and a pulse laser beam 33 may penetrate the through hole 24.

The EUV light generation apparatus 1 may include an EUV light generation controller 5, a target sensor 4, and the like. The target sensor 4 may have an imaging function, and may be configured to detect presence, locus, position, speed, and the like of a target 27.

The EUV light generation apparatus 1 may also include a connecting portion 29 that allows the inside of the chamber 2 and the inside of an exposure device 6 to communicate with each other. In the connecting portion 29, a wall 291 in which an aperture 293 is formed may be provided. The wall 291 may be arranged such that the aperture 293 is positioned at the second focal point of the EUV focusing mirror 23.

The EUV light generation apparatus 1 may also include a laser beam traveling direction control unit 34, a laser beam focusing mirror 22, and a target recovery unit 28 for recovering the target 27, and the like. The laser bean traveling direction control unit 34 may include an optical element for defining the traveling direction of the laser light, and an actuator for adjusting the position, posture, and the like of the optical element.

2.2 Operation

Referring to FIG. 1, a pulse laser beam 31 emitted from the laser device 3 may pass through the laser beam traveling direction control unit 34, penetrate the window 21 as a pulse laser beam 32, and enter the chamber 2. The pulse laser beam 32 may travel to the inside of the chamber 2 along at least one laser beam path, be reflected by the laser beam focusing mirror 22, and be radiated to at least one target 27 as a pulse laser beam 33.

The target supply unit 26 may be configured to output the target 27 to the plasma generation region 25 in the chamber 2. The target 27 may be irradiated with at least one pulse included in the pulse laser beam 33. The target 27 irradiated with the pulse laser beam is turned into plasma, and radiation 251 can be projected from the plasma. The EUV light 252 included in the radiation 251 may be selectively reflected by the EUV focusing mirror 23. The EUV light 252 reflected by the EUV focusing mirror 23 may be focused at the intermediate focusing point 292 and output to the exposure device 6. It should be noted that one target 27 may be irradiated with a plurality of pulses included in the pulse laser beam 33.

The EUV light generation controller 5 may be configured to control the entire EUV light generation system 11. The EUV light generation controller 5 may be configured to process image data of the target 27 captured by the target sensor 4, or the like. Further, the EUV light generation controller 5 may also be configured to control the timing of outputting the target 27 and the output direction of the target 27, for example. The EUV light generation controller 5 may also be configured to control the oscillation timing of the laser device 3, the traveling direction of the pulse laser beam 32, and the focusing position of the pulse laser beam 33, for example. The aforementioned various types of control are examples. Other types of control may be added as required.

3. Terms

The terms used in the present disclosure are defined as described below.

A “droplet” may be a droplet of a melted target material, and the shape thereof may be an approximately spherical shape.

A “plasma generation region” may be a three-dimensional space that has been set in advance as a space where plasma is generated.

4. Target supply device including vibrator unit

Next, an example of a target supply device including the target supply unit 26 illustrated in FIG. 1 will be described in detail with reference to the drawings.

4.1 Configuration

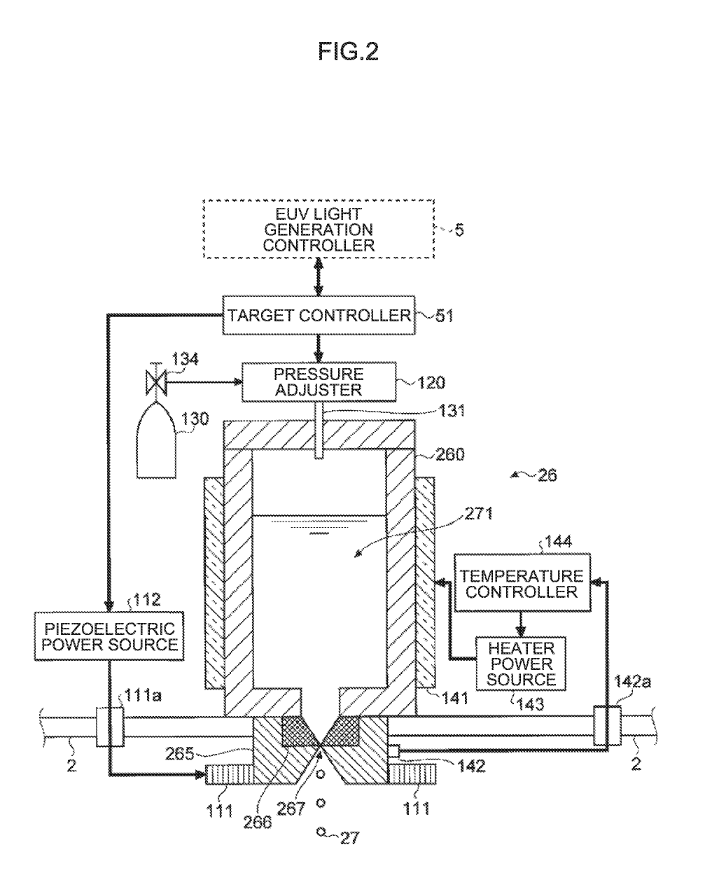

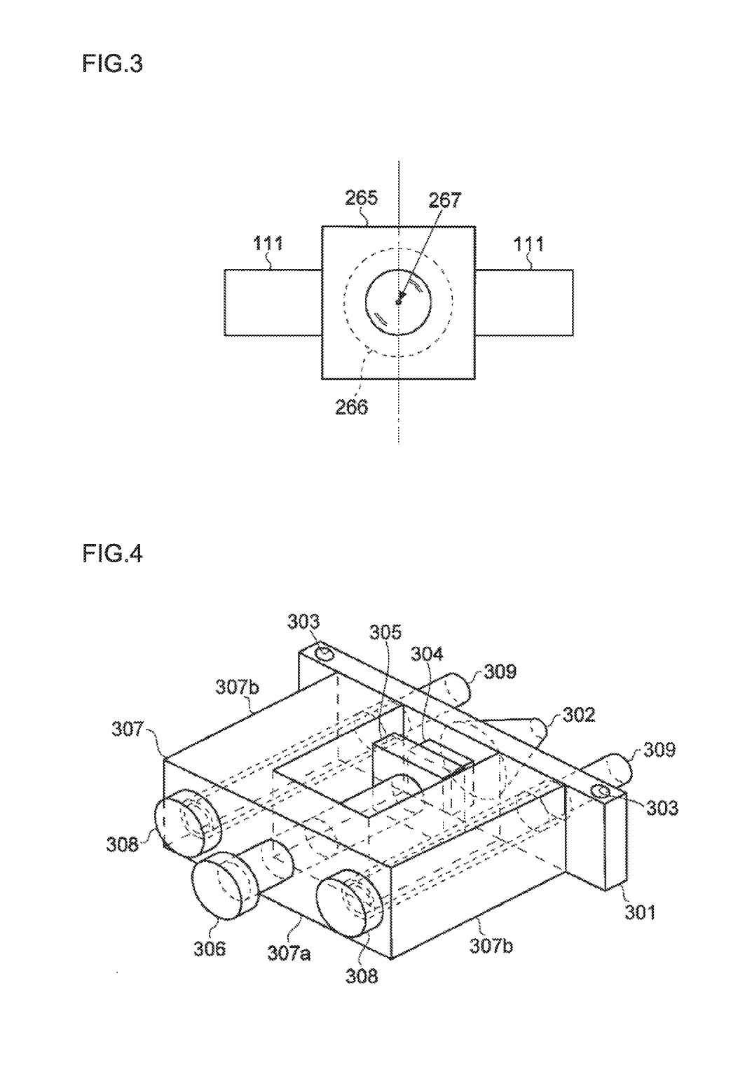

FIG. 2 is a schematic diagram illustrating an exemplary target supply device including the target supply unit illustrated in FIG. 1. FIG. 3 is a diagram illustrating a schematic configuration of the nozzle member, the nozzle holder, and the vibrator unit illustrated in FIG. 2, when seen from the target output direction.

As illustrated in FIG. 2, the target supply device may include a tank (first or second member) 260, a nozzle member 266, a pressure controller 120, a temperature controller 144, a target controller 51, a vibrator unit 111, and a piezoelectric power source 112.

In the tank 260, tin (Sn) that is a target material 271 may be stored. The tank 260 may be made of a material having low reactivity with tin. A material having low reactivity with tin may be molybdenum (Mo), for example.

The nozzle member 266 may have a nozzle hole 267 having a hole diameter of 3 to 6 μm. The nozzle member 266 may be made of a material having low reactivity with tin (Mo, for example). The nozzle member 266 may be fixed to the bottom of the tank 260 with a nozzle holder (first member) 265. The nozzle holder 265 may be made of a material having low reactivity with tin (Mo, for example). The part between the nozzle member 266 and the nozzle holder 265 and the part between the tank 260 and the nozzle member 266 may be face-sealed, respectively.

The pressure controller 120 may be connected with an inert gas cylinder 130. On the gas pipe between the cylinder 130 and the pressure controller 120, a valve 134 controllable by the pressure controller 120 may be provided. The pressure controller 120 may communicate with the inside of the tank 260 via an introduction pipe 131. The pressure controller 120 may introduce the inert gas, supplied from the cylinder 130, into the tank 260 via the introduction pipe 131.

The temperature controller 144 may be connected with a temperature sensor 142 and a heater power source 143. The temperature sensor 142 may be arranged to measure the temperature of the tank 260 or the nozzle holder 265. The heater power source 143 may be electrically connected with a heater 141. The heater power source 143 may supply electric current to the heater 141 in accordance with the control by the temperature controller 144. The heater 141 may be arranged to heat the target material 271 in the tank 260. For example, the heater 141 may be arranged on an outside surface of the tank 260.

The temperature sensor 142 and the temperature controller 144 may be electrically connected with each other via an introduction terminal 142a provided to a partition wall of the chamber 2. The introduction terminal 142a may electrically insulate a connecting line between the temperature sensor 142 and the temperature controller 144 from the chamber 2, while maintaining the airtightness of the chamber 2.

The piezoelectric power source 112 may be connected with the target controller 51 and a vibrator unit 111. The piezoelectric power source 112 and the vibrator unit 111 may be electrically connected with each other via an introduction terminal 111a provided to a partition wall of the chamber 2 similarly. The introduction terminal 111a may electrically insulate a connecting line between the piezoelectric power source 112 and the vibrator unit 111 from the chamber 2, while maintaining the airtightness of the chamber 2.

As illustrated in FIGS. 2 and 3, the vibrator unit 111 may be provided to a side face of the nozzle holder 265. When a plurality of vibrator units 111 are arranged, the vibrator units 111 may be arranged in line symmetry with the axis running through the center of the nozzle hole 267. The details of each vibrator unit 111 will be described below.

Further, as illustrated in FIG. 2, the target controller 51 may be connected with the vibrator unit 111, the temperature controller 144, the pressure controller 120, and the EUV light generation controller 5.

The inside of the tank 260 may communicate with the nozzle hole 267 via a target flow path provided on the bottom of the tank 260. The target flow path may be provided with a filter, not shown, for filtering the target material 271 flowing therein.

4.2 Operation

The target controller 51 illustrated in FIG. 2 may perform the following processes when a droplet output preparation signal is input from the EUV light generation controller 5 or from a controller of an external device.

That is, the target controller 51 may control the temperature controller 144 such that the temperature of the target material 271 in the tank 260 becomes a melting point or higher. Meanwhile, the temperature controller 144 may drive the heater power source 143 such that a detection value of the temperature sensor 142 becomes a predetermined temperature or higher. In the case of using tin (Sn) as the target material 271, for example, a predetermined temperature may be the temperature of a melting point of tin (232° C.) or higher. The predetermined temperature may be a temperature range. The temperature range may be a range from 240° C. to 290° C., for example.

Then, the target controller 51 may determine whether or not a detection value of the temperature sensor 142 maintains a predetermined temperature or higher for a predetermined time. When a predetermined temperature or a higher temperature is maintained for a predetermined time, the target controller 51 may notify the EUV light generation controller 5 or a controller of an external device of the fact that preparation for outputting a droplet (target 27) has been completed. Then, the target controller 51 may wait until a droplet output signal requesting outputting of a droplet is input.

Then, when a droplet output signal is input, the target controller 51 may control the pressure controller 120 to boost the pressure in the tank 260 to a predetermined pressure. A predetermined pressure may be about 10 MPa (megapascals), for example. The target controller 51 may also control the pressure controller 120 to maintain the pressure in the tank 260 at a predetermined pressure. In the state where the pressure in the tank 260 is maintained at a predetermined pressure, a jet of the target material 271 may be output from the nozzle hole 267.

Then, the target controller 51 may control the piezoelectric power source 112 such that a jet of the target material 271 discharged from the nozzle hole 267 is changed into droplets of a predetermined size in a predetermined cycle. Thereby, a voltage of a predetermined waveform may be applied from the piezoelectric power source 112 to the vibrator unit 111. The vibration generated in the vibrator unit 111 to which a voltage of a predetermined waveform is applied may be transmitted to the target material 271 via the nozzle holder 265, the nozzle member 266, and the tank 260. Consequently, the jet of the target material 271 may be divided so as to be changed into droplets of a predetermined size in a predetermined cycle.

5. Vibrator Unit: Comparative Example

Next, an example of the vibrator unit 111 illustrated in FIGS. 2 and 3 will be described in detail with reference to the drawings.

5.1 Configuration

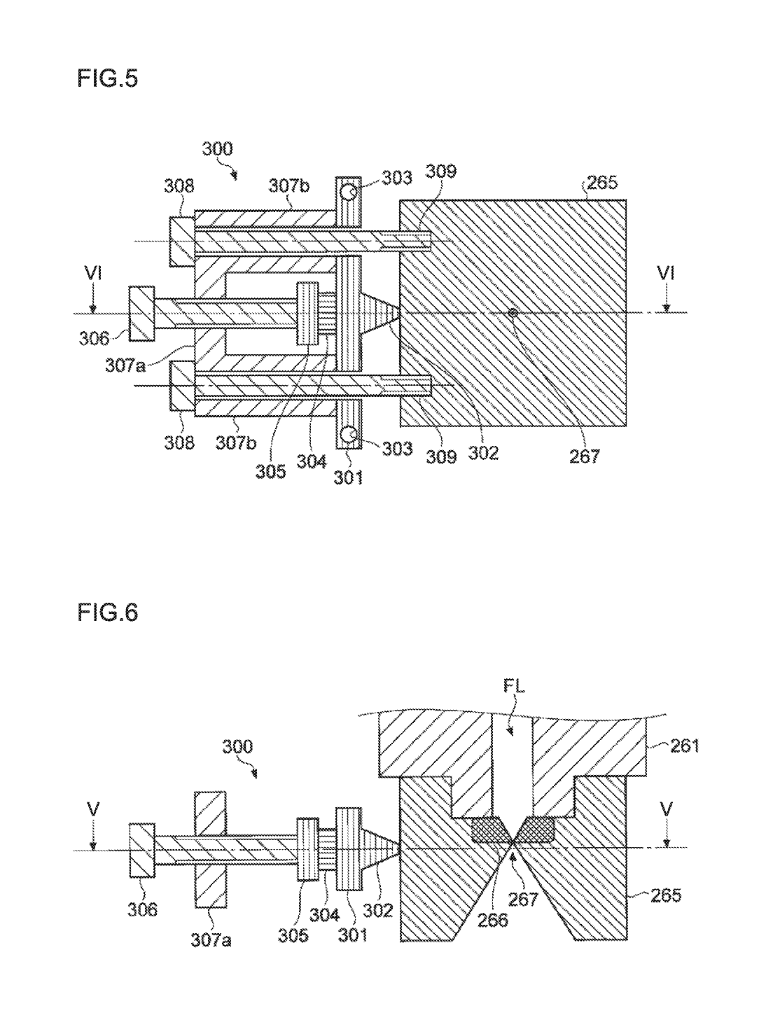

FIG. 4 is a perspective view illustrating an example of the vibrator unit illustrated in FIG. 2. FIG. 5 is a cross-sectional view of the vibrator unit illustrated in FIG. 4, showing a plane including the center axes of two first bolts 308, and FIG. 6 is a cross-sectional view showing a plane vertical to the cross section of FIG. 5 and including the center axis of a second bolt 306. It should be noted that FIG. 5 illustrates an example of a cross-sectional structure of a V-V plane illustrated in FIG. 6, and FIG. 6 illustrates an example of a cross-sectional structure of a VI-VI plane illustrated in FIG. 5.

A vibrator unit 300 illustrated in FIGS. 4 to 6 may include the two first bolts 308, the second bolt 306, a pressurizing frame 307, a pressing member 305, a piezo element 304, and a vibration transmission member 301.

The pressurizing frame 307 may be a frame member of the vibrator unit 300. The pressurizing frame 307 may include a center beam member 307a connecting one arm part 307b and the other arm part 307b located on both sides.

The vibration transmission member 301 may be arranged between the pressurizing frame 307 and the nozzle holder 265. At the center of the vibration transmission member 301, a protrusion 302 having a narrow truncated conical tip may be provided. The tip of the protrusion 302 may be in contact with a side face of the nozzle holder 265. The contact area between the tip of the protrusion 302 and a side face of the nozzle holder 265 may be smaller than the area of any one of the surfaces of the piezo element 304.

The two first bolts 308 may be used to fix the pressurizing frame 307 and the vibration transmission member 301 to a side face of the nozzle holder 265. As such, a threaded portion may be formed at the tip end 309 of the shaft of the first bolt 308. A side face of the nozzle holder 265 may be provided with two screw holes to which the tip ends 309 of the shafts of the two first bolts 308 are screwed. The two arm parts 307b in the pressurizing frame 307 and the vibration transmission member 301 may have two through holes for fitting the two first bolts 308, respectively.

The second bolt 306 may be an adjusting member for adjusting a pressure for pressing the piezo element 304 and the vibration transmission member 301 to the nozzle holder 265. As such, the center beam member 307a of the pressurizing frame 307 may have a screw hole for screwing the second bolt 306.

The vibration transmission member 301 may be energized to the nozzle holder 265 side by the second bolt 306 screwed to the pressurizing frame 307. Between the second bolt 306 and the vibration transmission member 301, the piezo element 304 and the pressing member 305 may be arranged. The second bolt 306 may press the protrusion 302 of the vibration transmission member 301 to the nozzle holder 265, while pressing the piezo element 304 to the vibration transmission member 301 via the pressing member 305.

The piezo element 304 may be a piezoelectric member configured to vibrate in response to an electric signal from the outside. The piezo element 304 may be connected to the piezoelectric power source 112 (see FIG. 2) by wiring not shown. The piezo element 304 may be a piezoelectric element using lead zirconate titanate. The vibration transmission member 301 may be provided with a cooling water pipe 303. The cooling water pipe 303 may be connected with a cooling water temperature regulator not shown.

It should be noted that the mounting position of the vibrator unit 300 is not limited to a side face of the nozzle holder 265. For example, the vibrator unit 300 may be mounted on a side face of the tank 260. This means that the vibrator unit 300 may be mounted at any location if it is a position where vibration can be applied to the target material 271 existing in the target flow path FL from the inside of the tank 260 to the nozzle hole 267.

5.2 Operation

In the vibrator unit 300 illustrated in FIGS. 4 to 6, pressurization to press the protrusion 302 of the vibration transmission member 301 to the nozzle holder 265 and pressurization to sandwich the piezo element 304 between the pressing member 305 and the vibration transmission member 301 (pressurization to the piezo element 304) may be applied by the second bolt 306.

Specifically, by screwing the first bolts 308, in a state of being screwed in the through holes of the arm parts 307b in the pressurizing frame 307 and the through holes of the vibration transmission members 301, into screw holes of the nozzle holder 265, pressurization to press the vibration transmission member 301 to the nozzle holder 265 may be applied to both sides of the vibration transmission member 301.

Further, by screwing the second bolt 306 into the beam member 307a of the pressurizing frame 307, pressurization to press the protrusion 302 to the nozzle holder 265 may be applied in the vicinity of the center of the vibration transmission member 301 via the pressing member 305 and the piezo element 304. Similarly, pressurization to sandwich the piezo element 304 between the pressing member 305 and the vibration transmission member 301 may be applied. It should be noted that pressurization applied by the second bolt 306 may be pressurization to press the protrusion 302 of the vibration transmission member 301 to the nozzle holder 265.

The pressurization described above may be adjusted by adjusting the screwing torque of the first bolts 308 and the second bolt 306. In that case, the screwing torque of the first bolts 308 and the second bolt 306 may be adjusted such that the vibration generated in the piezo element 304 reaches the target material 271 in the tank 260 via the protrusion 302 of the vibration transmission member 301.

The piezo element 304 may generate vibration through contraction based on the voltage of a predetermined waveform applied from the piezoelectric power source 112. The generated vibration may be transmitted to the target material 271 in the target flow path FL via the protrusion 302 of the vibration transmission member 301, the nozzle holder 265, the nozzle member 266, the tank 260, and the like. Thereby, a jet of the target material 271 discharged from the nozzle hole 267 can be changed to droplets of a predetermined size in a predetermined cycle.

The vibration transmission member 301 may be cooled by cooling water flowing in the cooling water pipe 303. Thereby, the temperature of the piezo element 304 may be prevented from becoming a Curie point or higher due to the heat from the heater 141 transmitted via the tank 260, the nozzle holder 265, and the like. The Curie point of the piezo element 304 may be in a range from 150° C. to 350° C.

5.3 Problem

Here, in order to reduce debris of the target material 271 generated in the chamber 2 of the EUV light generation apparatus 1, it is preferable to reduce the volume of the target 27 output in droplets. In order to output fine droplets, it is preferable to reduce a hole diameter (hereinafter referred to as a nozzle diameter) of the nozzle hole 267.

However, if the nozzle diameter is reduced in the target supply device including the vibrator unit 300, for example, there is a possibility that the generation cycle of droplets becomes unstable, because in the case of reducing the nozzle diameter, it is considered that the frequency of vibration which should be transmitted to the target material 271 for generating droplets stably is increased.

For example, if a vibration frequency necessary for generating droplets stably with a nozzle diameter of Φ 10 μm is 1.5 MHz (megahertz), in the case where the nozzle diameter is Φ 6 μm, a necessary vibration frequency may be 3 MHz.

Vibration having a frequency of 1.5 MHz can be transmitted to the target material 271 in a relatively good condition. However, the vibration of a high frequency which is required when the nozzle diameter is decreased may not be transmitted to the target material 271 with sufficient amplitude. In that case, as the force to divide the jet of the target material 271 is weakened, generation of droplets may be easily affected by the disturbance. Consequently, the generation cycle of droplets may be unstable.

In view of the above, a vibrator unit capable of transmitting vibration of a relatively high frequency with sufficient amplitude will be exemplary illustrated in the embodiments described below.

6. Vibrator Unit: First Embodiment

First, a vibrator unit according to a first embodiment will be described in detail with reference to the drawings.

As described above, it is desirable that members such as the nozzle holder 265 and the tank 260, which are brought into contact with the target material 271, have low reactivity with the target material 271. As such, selection of such materials is limited, and the best material that can transmit vibration efficiently may not always be selectable. In view of the above, in the first embodiment, materials having a relatively low vibration dumping rate may be used for members which are located on the path for transmitting generated vibration to the target material 271 and are not brought into contact with the target material 271.

In this example, a material having a relatively low vibration dumping rate may be a material having a lower vibration dumping rate than that of a member which is located on the path for transmitting generated vibration to the target material 271 and is brought into contact with the target material 271. Members which are located on the path for transmitting generated vibration to the target material 271 and are brought into contact with the target material 271 may include the nozzle holder 265, the nozzle member 266, and the tank 260, for example. Meanwhile, a member which is located on the path for transmitting generated vibration to the target material 271 and is not brought into contact with the target material 271 may be a vibration transmission member, for example.

6.1 Configuration

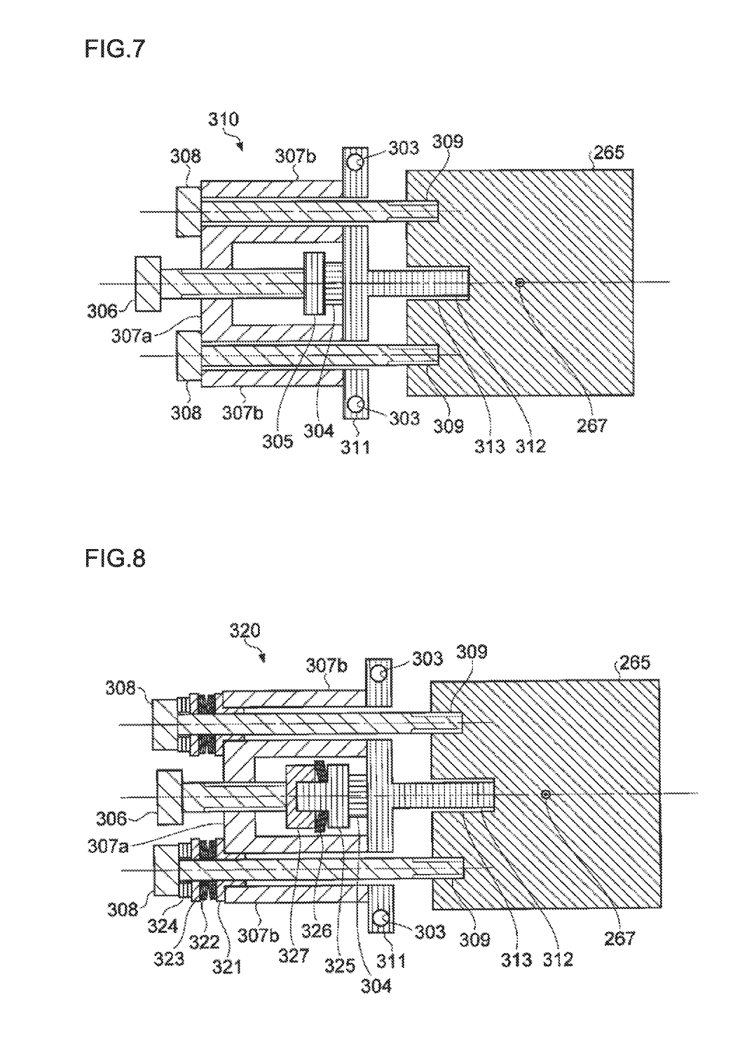

FIG. 7 is a cross-sectional view illustrating an exemplary schematic configuration of the vibrator unit according to the first embodiment. It should be noted that FIG. 7 illustrates an exemplary structure of a cross section corresponding to FIG. 5. In the below description, the same configurations as those of the vibrator unit 300 are denoted by the same reference numerals and the description thereof is not repeated.

As illustrated in FIG. 7, a vibrator unit 310 according to the first embodiment may have a configuration similar to that of the vibrator unit 300 provided that the vibration transmission member 301 may be replaced with a vibration transmission member 311.

The vibration transmission member 311 may have a configuration similar to that of the vibration transmission member 301 provided that the protrusion 302 may be replaced with a vibrator pin 312. The vibrator pin 312 may be integrated with another configuration of the vibration transmission member 311 or may be an independent member.

The vibrator pin 312 may be in a columnar shape. The circular cross-sectional area of the vibrator pin 312 may be smaller than any one surface of the piezo element 304.

The vibrator pin 312 may be formed of a material having a low vibration dumping rate than the materials of the nozzle holder 265, the tank 260, and the like. If molybdenum is used as a material of the nozzle holder 265, the tank 260, and the like, the logarithmic vibration dumping rate thereof can be 0.03. In that case, as a material of the vibrator pin 312, stainless steel having a logarithmic vibration dumping rate of 0.01 (<0.03) or the like may be used. Further, other configurations of the vibration transmission member 311 may be made of materials having a lower vibration dumping rate than that of the materials of the nozzle holder 265, the tank 260, and the like.

Further, a vibrator hole 313 may be formed at a contact portion, with the vibration transmission member 311, in the nozzle holder 265. The tip of the vibrator pin 312 may be brought into contact with the bottom of the vibrator hole 313. The vibrator hole 313 may be in a dented shape from a side face of the nozzle holder 265 toward the target flow path FL. This means that the vibrator hole 313 may be in a shape allowing a contact position between the vibrator pin 312 and the nozzle holder 265 to approach the target flow path FL. The shortest distance between the contact surface (that is, the bottom of the vibrator hole 313) and the target flow path FL may range from 2 to 5 mm, for example. More preferable, the shortest distance may be 3 mm

The opening shape of the vibrator hole 313 is not limited to a circle. Various types of shapes such as a triangle and a square are applicable. Further, the vibrator hole 313 may be a groove formed on one side face of the nozzle holder 265.

Similar to the case of the vibrator unit 300, the mounting position of the vibrator unit 310 is not limited to a side face of the nozzle holder 265. For example, the vibrator unit 310 may be mounted on a side face of the tank 260. In that case, it is preferable that the vibrator hole 313 is also formed on the side face of the tank 260. This means that the vibrator unit 310 may be mounted at any position if vibration can be applied to the target material 271 existing in the target flow path FL. The vibrator hole 313 is preferably formed corresponding to the mounting position of the vibrator unit 310.

6.2 Operation

Similar to the case of the vibrator unit 300 illustrated in FIGS. 4 to 6, in the vibrator unit 310 illustrated in FIG. 7, vibration generated in the piezo element 304 may be transmitted to the target material 271 in the target flow path FL via the vibrator pin 312 of the vibration transmission member 311, the nozzle holder 265, the nozzle member 266, the tank 260, and the like. Thereby, a jet of the target material 271 ejected from the nozzle hole 267 may be divided to be changed into droplets of a predetermined size in a predetermined cycle.

6.3 Effect

As described above, in the vibrator unit 310 according to the first embodiment, the vibration transmission member 311 which is a portion of a transmission path for the generated vibration to the target material 271 may be made of a material having a vibration dumping rate lower than that of the nozzle holder 265, the tank 260, and the like. Thereby, vibration generated in the piezo element 304 can be transmitted efficiently to the target material 271 in the target flow path FL.

Further, by providing the vibrator hole 313 that allows a contact face between the vibrator pin 312 and the nozzle holder 265 to approach the target flow path FL, a section where the vibration dumping rate is larger than that of the vibration transmission member 311 in the vibration transmission path from the piezo element 304 to the target material 271 can be shortened. Thereby, vibration can be transmitted to the target material 271 more efficiently.

Further, in the case where the vibrator pin 312 is integrated with another configuration of the vibration transmission member 311, the number of components on the vibration transmission path can be reduced, so that vibration damping caused at component joints can be reduced. Thereby, the vibration can be transmitted to the target material 271 more efficiently.

As a result, even in the case where the nozzle diameter is decreased, high frequency vibration can be transmitted to the target material 271 with sufficient amplitude. Thereby, droplets can be generated stably.

Other configurations, operations, and effects may be the same as those of the vibrator unit 300 described above.

7. Vibrator Unit: Second Embodiment

Next, a vibrator unit according to a second embodiment will be described in detail with use of the drawings.

In the configurations illustrated in FIGS. 4 to 6, for example, in the case of heating the tank 260, the nozzle holder 265, and the like to output the target 27, the temperature of the first bolt 308 in the vibrator unit 300 may also be increased by the heat. As a result, the temperature of the first bolt 308 may become the same as that of the tank 260 or the like. Meanwhile, as the vibration transmission member 301 is cooled by the cooling water flowing in the cooling water pipe 303, the temperature may be several tens of degrees.

In the configuration where a large temperature difference may be caused as described above, when the vibrator unit 300 fabricated at the room temperature is heated in a state of being assembled to the nozzle holder 265, the tank 260, and the like, the first bolt 308 may expand in the extending direction by the heat whereby the contact face pressure between the respective members may be lowered. Then, the pressurization to press the vibration transmission member 301 to the nozzle holder 265, the tank 260, and the like and the pressurization to sandwich the piezo element 304 may decrease or fluctuate.

Specifically, while the first bolt 308 in which the temperature is rising extends in the extending direction by the thermal expansion, the thermal expansion of the vibration transmission member 301 and the pressurizing frame 307, which are cooled, can be suppressed. Thereby, the force of the first bolt 308 to press the pressurizing frame 307 and the vibration transmission member 301 to the nozzle holder 265, the tank 260, and the like can be lowered. As such, the pressurization that the pressurizing frame 307 applies to the vibration transmission member 301 can be lowered. Similarly, the pressurization that the second bolt 306 applies to the vibration transmission member 301 via the pressing member 305 and the piezo element 304 can also be lowered. Further, the pressurization to sandwich the piezo element 304 between the pressing member 305 and the vibration transmission member 301 can also be lowered. Due to these factors, the vibration transmission efficiency when the vibration generated in the piezo element 304 is transmitted to the target material 271 can be lowered.

Such looseness by the thermal expansion can be solved by adjusting the screwing torque of the first bolt 308 and the second bolt 306. However, there may be irregularities in the accuracy of tools such as a torque wrench for turning each bolt, the friction between the threaded portion and the screw hole, and the like. As such, there is a possibility that the pressurization applied to the vibration transmission member 301 by the first bolt 308 and the pressurization applied to the vibration transmission member 301 and the piezo element 304 by the second bolt 306 differ by each vibrator unit 300. Consequently, the transmission efficiency of the vibration generated in the piezo element 304 may have a machine difference in each vibrator unit 300.

In view of the above, in the second embodiment, a vibrator unit capable of suppressing a drop of pressurization due to the thermal expansion of a member will be exemplary described. It should be noted that while a configuration based on the vibrator unit 310 illustrated in FIG. 7 will be exemplary described in the second embodiment, other embodiments exemplary illustrated in the present disclosure may also be used as the base.

7.1 Configuration

FIG. 8 is a cross-sectional view illustrating an exemplary schematic configuration of a vibrator unit according to the second embodiment. It should be noted that FIG. 8 illustrates an exemplary structure of a cross section corresponding to FIG. 7. Further, in the below description, the same configurations as those of the vibrator unit 310 are denoted by the same reference numerals and the description thereof is not repeated.

As illustrated in FIG. 8, a vibrator unit 320 according to the second embodiment may further include a first elastic member 322, a second elastic member 326, a first seat 321, a second seat 327, a washer 323, and a shim 324, in addition to the configurations similar to those of the vibrator unit 310 illustrated in FIG. 7. Further, the pressing member 305 in the vibrator unit 310 may be replaced with a pressing member 325.

The first elastic member 322 may be arranged between the head portion of the first bolt 308 and the pressurizing frame 307. Between the first elastic member 322 and the pressurizing frame 307, the first seat 321 may be arranged. Meanwhile, between the first elastic member 322 and the head portion of the first bolt 308, the washer 323 and one or more shims 324 may be arranged.

At the tip of the shaft of the second bolt 306, the second seat 327 may be arranged. The second seat 327 and the pressing member 325 may have a protruding portion and a dented portion that engage with each other. The second elastic member 326 may be arranged between the second seat 327 and the pressing member 325.

The first elastic member 322 may be a ring-shaped member that can be fitted with the shaft of the first bolt 308. Similarly, the second elastic member 326 may be a ring-shaped member that can be fitted with the protruding portion of the second seat 327 or the pressing member 325. The first and second elastic members 322 and 326 may be disc springs, and the first seat 321 and the second seat 327 each may hold the first elastic member 322 or the second elastic member 326 in a deformable manner.

7.2 Operation

In the vibrator unit 320 illustrated in FIG. 8, fluctuation of the pressurization (a drop of pressurization, for example) applied to the both ends of the vibration transmission member 311 caused by a difference in the thermal expansion between respective units can be eased by the elastic force and the stroke of the first elastic member 322.

Further, fluctuation of the pressurization (a drop of pressurization, for example) applied in the vicinity of the center of the vibration transmission member 311 (that is, vibrator pin 312) can be eased by the elastic force and the stroke of the first elastic member 322 and the second elastic member 326.

Further, fluctuation of the pressurization applied to the piezo element 304 can be eased by the elastic force and the stroke of the first elastic member 322 and the second elastic member 326.

When disc springs are used as the first elastic member 322 and the second elastic member 326, by adjusting the number of pieces, overlapping direction, hardness, and the like thereof, the elastic force and the stroke of each of them may be adjusted.

A load (preload) previously given to the first elastic member 322 and the second elastic member 326 may be regulated by adjusting the screwing torque of the first bolt 308 and the second bolt 306. Further, when the shim 324 is interposed between them like the first bolt 308 and the first elastic member 322, by adjusting the thickness and the number of pieces of the shims 324, the preload to the first elastic member 322 and the stroke thereof may be adjusted.

The pressurization to the vibration transmission member 311(vibrator pin 312) and the pressurization to the piezo element 304 may be adjusted such that the surface pressure between the vibrator pin 312 and the nozzle holder 265 becomes larger than the surface pressure between the piezo element 304 and the vibration transmission member 311, for example. At that time, the surface pressure between the piezo element 304 and the vibration transmission member 311 may be adjusted to about 30 MPa, for example.

7.3 Effect

With the configuration described above, in the vibrator unit 320 of the second embodiment, when heating is performed for outputting the target 27, it is possible to suppress fluctuation of the pressurization to the vibration transmission member 311 (vibrator pin 312) and the pressurization to the piezo element 304.

Further, by using the first elastic member 322 and the second elastic member 326 that can be deformed (stroke), the shim 324, and the like, it is possible to significantly improve the degree of freedom of adjustment of the pressurization to the vibration transmission member 311 (vibrator pin 312) and the pressurization to the piezo element 304. Thereby, the pressurization to the vibration transmission member 311 (vibrator pin 312) and the pressurization to the piezo element 304 can be adjusted with high accuracy. Therefore, it is possible to decrease the machine difference that the transmission efficiency of the vibration generated in the piezo element 304 differs by each vibrator unit 300.

It should be noted that each of the parts (particularly the first bolt 308 and the second bolt 306) of the vibrator unit 320 may be made of a material having a relatively small thermal expansion coefficient. A material having a relatively small thermal expansion coefficient may be an alloy mainly made of invar and nickel, for example.

Further, each of the first bolt 308 and the second bolt 306 may be configured of a material having a relatively low thermal conductivity. A material having a relatively low thermal conductivity may be ceramic such as aluminum nitride, silicon carbide, boron nitride, or the like.

It should be noted that other configurations, operations, and effects may be the same as those of the embodiment described above.

8. Vibrator Unit: Third Embodiment

Next, a vibrator unit according to a third embodiment will be described in detail with use of the drawings.

In the embodiments described above, a configuration in which the vibrator unit 310 or 320 is mounted on the nozzle holder 265 or the tank 260 has been exemplary illustrated. However, the mounting position of the vibrator unit is not limited to the nozzle holder 265 or the tank 260. In the third embodiment, another mounting position of the vibrator unit will be exemplary illustrated. It should be noted that while a configuration based on the vibrator unit 320 illustrated in FIG. 8 is exemplary illustrated in the third embodiment, other embodiments exemplary illustrated in the present disclosure can be used as the base, similarly.

8.1 Configuration

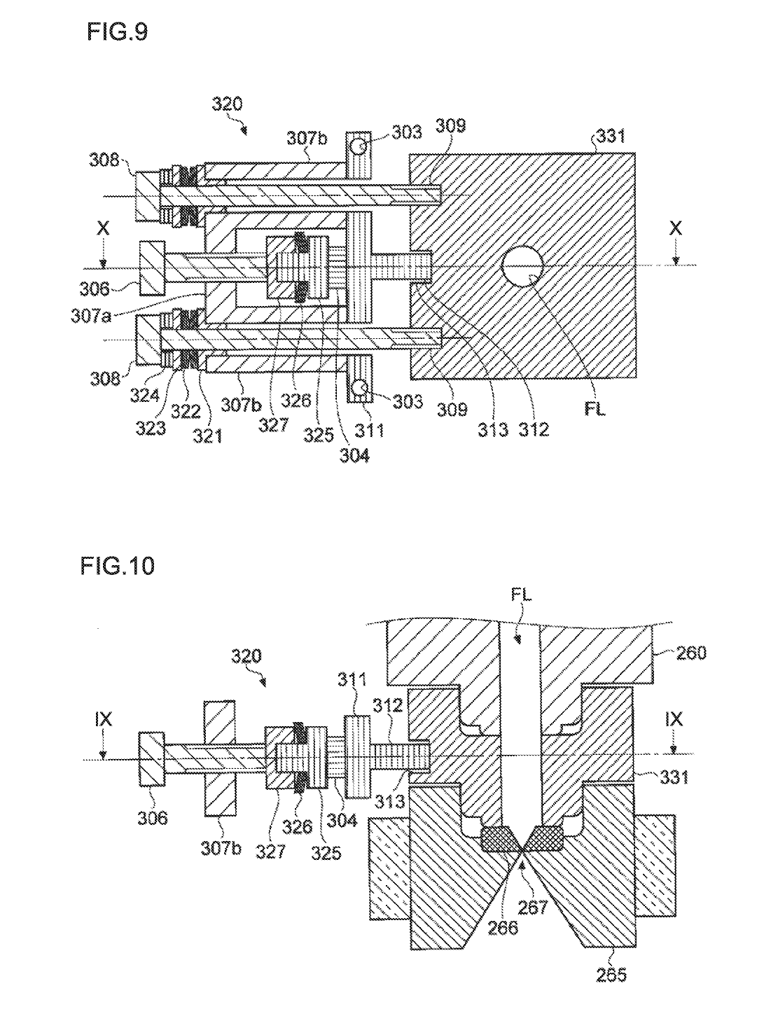

FIG. 9 is a cross-sectional view of exemplary mounting of a vibrator unit according to the third embodiment. FIG. 9 illustrates an exemplary structure of a cross section corresponding to FIG. 8. However, the mounting position of the vibrator unit differs from that of FIG. 8. FIG. 10 is a cross-sectional view of exemplary mounting illustrated in FIG. 9. FIG. 9 illustrates an exemplary structure of a cross section of a IX-IX plane in FIG. 10, and FIG. 10 illustrates an exemplary structure of a cross section of a X-X plane in FIG. 9. In the below description, the same configurations as those illustrated in FIG. 8 are denoted by the same reference numerals and the description thereof is not repeated.

As illustrated in FIGS. 9 and 10, a vibration transmission member (first or third member) 331 may be arranged between the tank 260 and the nozzle holder 265. As such, a protruding portion or a dented portion, to be engaged with a dented portion or a protruding portion of the vibration transmission member 331, may be provided on the bottom of the tank 260. Further, the nozzle holder 265 may be provided with a dented portion or a protruding portion to be engaged with the protruding portion or the dented portion of the vibration transmission member 331. The part between the tank 260 and the vibration transmission member 331, and the part between the vibration transmission member 331 and the nozzle holder 265 may be face-sealed.

The vibration transmission member 331 may be provided with a flow path that communicates with the target flow path FL of the tank 260 and extends the target flow path FL to the nozzle member 266 of the nozzle holder 265. Hereinafter, such a flow path is also referred to as the target flow path FL without distinguishing it from the target flow path FL.

The contact area between the vibration transmission member 331 and the target material 271, that is, the inner surface area of the target flow path FL in the vibration transmission member 331, may be smaller than the contact area with the target material 271 in the tank 260. Accordingly, the vibration transmission member 331 may be a member having a smaller volume than that of the tank 260.

The material of the vibration transmission member 331 may be a material having low reactivity with the target material 271. Further, the material of the vibration transmission member 331 may be a material having a thermal expansion rate similar to that of the material of the tank 260 and the like. As such, in the case where the tank 260 is made of molybdenum, molybdenum may be used as a material of the vibration transmission member 331.

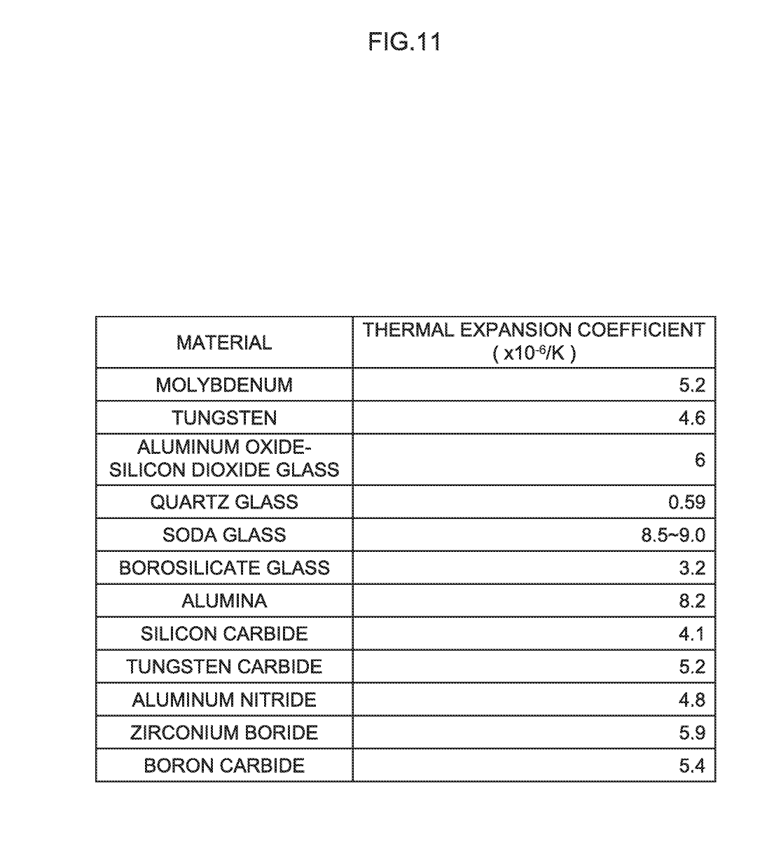

Further, the material of the vibration transmission member 331 may be a material having a lower vibration dumping rate than that of the material of the tank 260 or the nozzle holder 265. FIG. 11 illustrates exemplary materials selectable as a material of the vibration transmission member 331. Among the materials listed in FIG. 11, molybdenum, silicon carbide, tungsten carbide, aluminum nitride, zirconium boride, and boron carbide can be particularly effective as a material of the vibration transmission member 331.

A side face of the vibration transmission member 331 may be provided with two screw holes into which tip ends 309 of the two first bolts 308 in the vibrator unit 320 are fitted. The vibrator unit 320 may be fixed to the vibration transmission member 331 by fitting the tip ends 309 of the two first bolts 308 into the two screw holes. Further, a side face of the vibration transmission member 331 may be provided with the vibrator hole 313 corresponding to the vibrator pin 312.

8.2 Operation

In the configuration illustrated in FIGS. 9 and 10, vibration generated in the piezo element 304 may be transmitted to the target material 271 in the target flow path

FL from the vibrator pin 312 of the vibration transmission member 311 via the vibration transmission member 331. Thereby, a jet of the target material 271 discharged from the nozzle hole 267 may be divided to be changed into droplets of a predetermined size in a predetermined cycle.

8.3 Effect

As described above, in the configuration according to the third embodiment, vibration generated in the vibrator unit 320 can be directly transmitted to the vibration transmission member 331 in direct contact with the target material 271 in the target flow path FL. Thereby, vibration can be transmitted to the target material 271 in the target flow path FL more efficiently.

Further, with use of a material having a low vibration dumping rate for the vibration transmission member 331, vibration can be transmitted to the target material 271 in the target flow path FL more efficiently.

Further, with use of a smaller member for the vibration transmission member 331 than the tank 260, it is possible to suppress vibration energy from being consumed because of the entire member being vibrated. Further, as it is possible to configure a contact area with the target material 271 to be small, the density of the vibration energy transmitted to the contact surface with the target material 271 can be high. Thereby, vibration can be transmitted to the target material 271 in the target flow path FL more efficiently.

Other configurations, operations, and effects may be similar to those of the embodiments described above.

9. Modifications of Vibrator Pin

Next, modifications of the vibrator pin 312 exemplary illustrated in the embodiments described above will be described in detail with reference to the drawings.

The tip portion of the vibrator pin 312 may be in a tapered shape such that it has a smaller cross-sectional area compared with a cross-sectional area of the root side. A cross-section area in this case may be a cross-sectional area of a plane vertical to the extending direction of the vibrator pin 312. Further, when the vibrator pin 312 is in an almost cylindrical shape, it may be a cross-sectional area of the cylinder.

9.1 First Modification

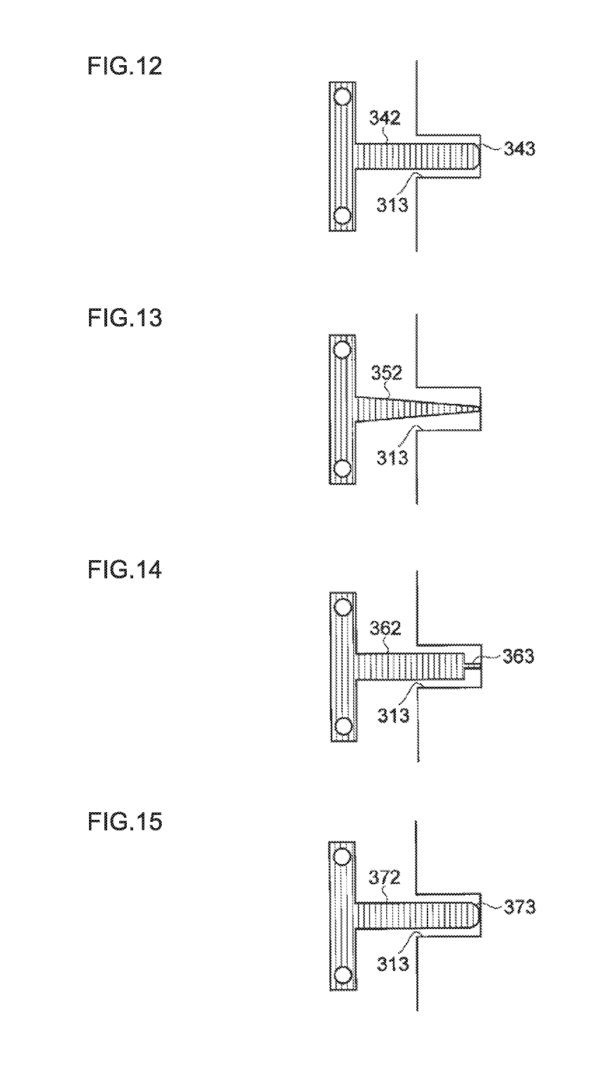

FIG. 12 is a cross-sectional view illustrating a schematic shape of a vibrator pin according to a first modification. As illustrated in FIG. 12, a tip portion 343 of a vibrator pin 342 may be in a tapered shape such that the cross-sectional area thereof is contracted.

9.2 Second Modification

FIG. 13 is a cross-sectional view illustrating a schematic shape of a vibrator pin according to a second modification. As illustrated in FIG. 13, a tapered shape, tapering toward the tip, may be the entire shape of a vibrator pin 352, not limited to the tip portion.

9.3 Third Modification

FIG. 14 is a cross-sectional view illustrating a schematic shape of a vibrator pin according to a third modification. As illustrated in FIG. 14, a vibrator pin 362 may have a narrower tip portion 363 than the body portion of the root side. For example, in the case where the vibrator pin 362 is in an almost cylindrical shape, the tip portion 363 may be narrower and in an almost cylindrical shape with a stepwise level difference.

9.4 Fourth Modification

FIG. 15 is a cross-sectional view illustrating a schematic shape of a vibrator pin according to a fourth modification. As illustrated in FIG. 15, a tip portion 373 of a vibrator pin 372 may be in a protruded curved face shape. The protruded curved face may be any of various curved faces such as a spherical face, a spheroidal face, and a hyperboloidal face. In that case, a contact between the vibrator hole 313 and the tip portion 373 may be a point contact substantially.

9.5 Effect of Modification

According to the modifications exemplary illustrated above, a contact area between the vibration transmission member 311 that is a vibration transmission unit and the nozzle holder 265 or the tank 260 (or the vibration transmission member 331) can be decreased. Thereby, vibration can be transmitted more efficiently.

In the case where a vibrator pin is simply narrowed, the rigidity of the vibrator pin itself may be lowered, whereby vibration may be damped in the vibrator pin 312. As such, with a configuration in which the cross-sectional area near the contact portion is decreased while maintaining the rigidity of the body portion of the vibrator pin as described in the aforementioned modifications, it is possible to transmit vibration more efficiently while suppressing lowering of the rigidity of the vibrator pin.

10. Modifications of Contact Form between Vibrator Pin and Vibrator Hole

Next, modifications of a contact form between the vibrator pin 312 and the vibrator hole 313 exemplary illustrated in the aforementioned embodiments will be described in detail with reference to the drawings.

In the aforementioned embodiments, the tip face of the vibrator pin 312 and the bottom face of the vibrator hole 313 may be planes. In that case, the tip of the vibrator pin 312 and the bottom face of the vibrator hole 313 can form a surface contact substantially. However, the present disclosure is not limited to this form. For example, as exemplary shown in the fourth modification illustrated in FIG. 15, the tip of the vibrator pin and the bottom face of the vibrator hole may form a point contact or a line contact.

10.1 First Modification

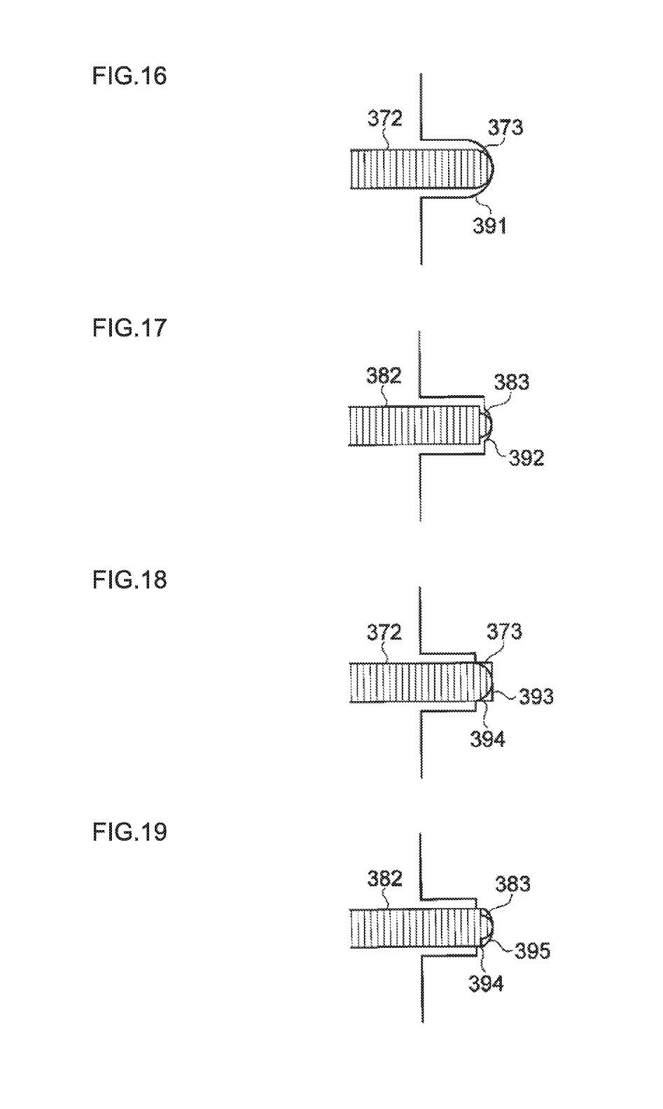

FIG. 16 is a cross-sectional view illustrating an example of a contact form between a vibrator pin and a vibrator hole according to a first modification. As illustrated in FIG. 16, in the case where the tip portion 373 of the vibrator pin 372 is in a protruded curved face shape, the bottom face of the vibrator hole 391 accepting it may be in a recessed curved face shape. The protruded curved face and the recessed curved face may be any of various curved faces such as a spherical face, a spheroidal face, and a hyperboloidal face.

The recessed curved face of the bottom face of the vibrator hole 391 may be in a shape closer to a plane face than the protruded curved face of the tip portion 373. For example, in the case where both the protruded curved face of the tip portion 373 and the recessed curved face of the bottom face of the vibrator hole 391 are spheres, the radius of curvature of the protruded spherical face of the tip portion 373 may be smaller than the radius of curvature of the recessed sphere face of the bottom face of the vibrator hole 391.

10.2 Second Modification

FIG. 17 is a cross-sectional view illustrating an exemplary contact form between a vibrator pin and a vibrator hole according to a second modification. As illustrated in FIG. 17, in a tip portion 383 of a vibrator pin 382, a portion having a protruded curved face may be a portion of the tip face. Similarly, in the inner face of a vibrator hole 392, a portion having a recessed curved face may be a portion of the bottom face. Even in the exemplary form illustrated in FIG. 17, the recessed curved face of the bottom face of the vibrator hole 392 may be in a shape closer to a plane face than the protruded curved face of the tip portion 383.

10.3 Effect of First and Second Modifications

According to the first and second modifications of a contact form between a vibrator pin and a vibrator hole, as a contact form between the vibrator pin and the bottom surface of the vibrator hole is a point contact substantially, it is possible to significantly decrease the contact area between the vibration transmission member 311 that is a vibration transmission unit and the nozzle holder 265 or the tank 260 (or vibration transmission member 331). Consequently, vibration can be transmitted more efficiently.

10.4 Third Modification

FIG. 18 is a cross-sectional view illustrating an exemplary contact form between a vibrator pin and a vibrator hole according to a third modification. As illustrated in FIG. 18, the bottom face of a vibrator hole 393 may have a positioning part 394 for forming multipoint contact or line contact with the surrounding portion of the tip portion 373, besides the face where a point contact is made with the utmost tip portion of the tip portion 373 of the vibrator pin 372. In that case, the vibrator pin 372 may be in a shape similar to the vibrator pin 372 illustrated in FIG. 16.

The positioning part 394 may be a stepwise level difference around the bottom face of the vibrator hole 393. The positioning part 394 may be in contact with the surrounding portion of the tip portion 373 so as to retain the vibrator pin 372 at a correct position with respect to the vibrator hole 393.

10.5 Fourth Modification

FIG. 19 is a cross-sectional view illustrating an exemplary contact form between a vibrator pin and a vibrator hole according to a fourth modification. Like a vibrator hole 395 illustrated in FIG. 19, in the vibrator hole 393 illustrated in FIG. 18, the face brought into point-contact with the upmost tip portion of the tip portion 373 of the vibrator pin 372 may be a recessed curved face. In that case, the vibrator pin 382 may be in a shape similar to that of the vibrator pin 382 illustrated in FIG. 17.

The positioning part 394 in the fourth modification may form multipoint contact, line contact, or face contact with the body portion of the vibrator pin 382.

10.6 Effect of Third and Fourth Modifications

As described above, by providing the positioning part 394 for positioning a vibrator pin with respect to a vibrator hole, it is possible to suppress positional displacement of the vibrator pin and to regulate the contact portion with the inner face of the vibrator hole within a certain range. Thereby, it is possible to suppress fluctuation of the vibration transmission position from the vibrator pin to the inner face of the vibrator hole which may be caused by irregularities in assembling. Consequently, a machine difference in vibration transmission due to irregularities in assembling can be reduced.

It should be noted that the shape of the positioning part 394 is not limited to the level difference described above. For example, the shape of the positioning part 394 may be designed based on a given fitting tolerance with respect to the outer shape of the opposing vibrator pin.

11. Vibrator Unit: Fourth Embodiment

Next, a vibrator unit according to a fourth embodiment will be described in detail with use of the drawings.

For example, in the configuration illustrated in FIG. 8, fluctuation of pressurization to the piezo element 304 can be eased by the elastic force and the stroke of the first and second elastic members 322 and 326.

The elastic force and the stroke of the first and second elastic members 322 and 326 can be adjusted not by adjusting the first and second elastic members 322 and 326 themselves but also adjusting preload to the first and second elastic members 322 and 326.

Adjustment of preload to the first and second elastic members 322 and 326 is preferable on the points that it is easier than adjustment of the first and second elastic members 322 and 326 themselves and irregularities in the adjustment accuracy are small.

Accordingly, in order to suppress fluctuation of pressurization to the piezo element 304, it is considered to adjust preload to the first and second elastic members 322 and 326.

Preload to the first elastic member 322 can be adjusted not only by adjusting the screwing torque of the first bolt 308 but also by adjusting the thickness and the number of pieces of the shims 324 interposed between the first bolt 308 and the first elastic member 322.

Regarding the screwing torque of each bolt, a machine difference is likely to be caused by each bolt due to the tool accuracy of a torque wrench for turning each bolt and irregularities in the friction between the threaded portion and the screw hole, for example.

As such, regarding preload to the first elastic member 322, it is preferable to perform adjustment by adjusting the thickness or the number of pieces of the shims 324, rather than adjusting the screwing torque of the first bolt 308, because a machine difference is less likely to be caused by each vibrator unit 320.

On the other hand, regarding preload to the second elastic member 326, as there is no shim between the second bolt 306 and the second elastic member 326, it may be necessary to perform adjustment by adjusting the screwing torque of the second bolt 306.

As such, regarding preload to the second elastic member 326, a machine difference may be caused by each vibrator unit 320.

Accordingly, in order to suppress fluctuation of pressurization to the piezo element 304, it can be considered to adjust preload to the first elastic member 322 by adjusting the thickness or the number of pieces of the shims 324.

However, the second elastic member 326 is closer to the piezo element 304 than the first elastic member 322. Therefore, fluctuation of the pressurization to the piezo element 304 is likely to be eased by the elastic force and the stroke of the second elastic member 326, rather than those of the first elastic member 322. This means that by adjusting the elastic force and the stroke of the second elastic member 326, an effect of suppressing fluctuation of pressurization to the piezo element 304 may be larger, compared with the case of the first elastic member 322.

In other words, by adjusting the preload to the second elastic member 326, an effect of suppressing fluctuation of pressurization to the piezo element 304 can be larger, compared with the case of the first elastic member 322.

In view of the above, in the fourth embodiment, a vibrator unit will be exemplary described in which fluctuation of pressurization to the piezo element 304 can be suppressed while reducing a machine difference caused in preload to the second elastic member 326. It should be noted that in the fourth embodiment, while a configuration based on the vibrator unit 320 illustrated in FIG. 8 is exemplary shown, other embodiments exemplary shown in the present disclosure can be used as the base, similarly.

11.1 Configuration

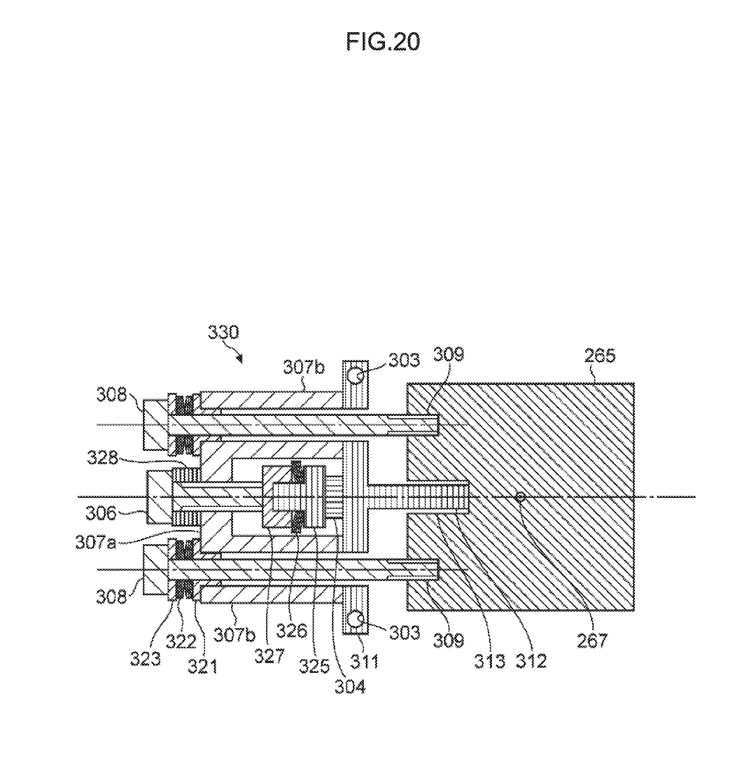

FIG. 20 is a cross-sectional view illustrating an exemplary schematic configuration of a vibrator unit according to a fourth embodiment. FIG. 20 illustrates an exemplary structure of a cross section corresponding to FIG. 8. Further, in the below description, the same configurations as those of the vibrator unit 320 are denoted by the same reference numerals and the description thereof is not repeated.

As illustrated in FIG. 20, in a vibrator unit 330 according to the fourth embodiment, the shim 324 may be omitted and a shim 328 may be added, in addition to the same configurations as those of the vibrator unit 320 illustrated in FIG. 8.

The shim 328 may be arranged between the beam member 307a of the pressurizing frame 307 and the head of the second bolt 306.

A plurality of shims 328 may be provided. The thickness of each of the shims 328 may be the same or different.

11.2 Operation

In the vibrator unit 330 illustrated in FIG. 20, preload to the second elastic member 326 may be adjusted by adjusting the thickness or the number of pieces of the shims 328 interposed between the second bolt 306 and the second elastic member 326. Thereby, the elastic force and the stroke of the second elastic member 326 may be adjusted with high accuracy and fluctuation of pressurization to the piezo element 304 can be suppressed.

Similar to the case of the second embodiment, pressurization to the piezo element 304 may be adjusted such that the surface pressure between the piezo element 304 and the vibration transmission member 311 becomes smaller than the surface pressure between the vibrator pin 312 and the nozzle holder 265. In that case, the surface pressure between the piezo element 304 and the vibration transmission member 311 may be adjusted to about 30 MPa, for example, which is similar to the case of the second embodiment.

11.3 Effect

With the configuration as described above, in the vibrator unit 330 according to the fourth embodiment, it is possible to adjust preload with high accuracy while reducing a machine difference in the preload to the second elastic member 326.

Thereby, in the vibrator unit 330 of the fourth embodiment, it is possible to adjust the elastic force and the stroke of the second elastic member 326 with high accuracy and to efficiently suppress fluctuation of pressurization to the piezo element 304.

Consequently, in the vibrator unit 330 of the fourth embodiment, as pressurization to the piezo element 304 can be adjusted with high accuracy, transmission efficiency of the vibration generated in the piezo element 304 can be improved.

Other configurations, operations, and effects may be the same as those of the embodiments described above.

While, in the vibrator unit 330 of FIG. 20, an example in which the shim 324 in the vibrator unit 320 of FIG. 8 is omitted is illustrated, the shim 324 may not be omitted in the vibrator unit 330 of the fourth embodiment.

12. Vibrator Unit: Fifth Embodiment

Next, a vibrator unit according to a fifth embodiment will be described in detail with use of the drawings.

In the fourth embodiment, a configuration in which the vibrator unit 330 is mounted on the nozzle holder 265 or the tank 260 has been exemplary illustrated. In the fifth embodiment, it may be mounted on the vibration transmission member 331 including the target flow path FL therein, which is similar to the third embodiment. It should be noted that while a configuration based on the vibrator unit 330 illustrated in

FIG. 20 is exemplary shown in the fifth embodiment, it is also possible to use other embodiments exemplary shown in the present disclosure as the base.

12.1 Configuration

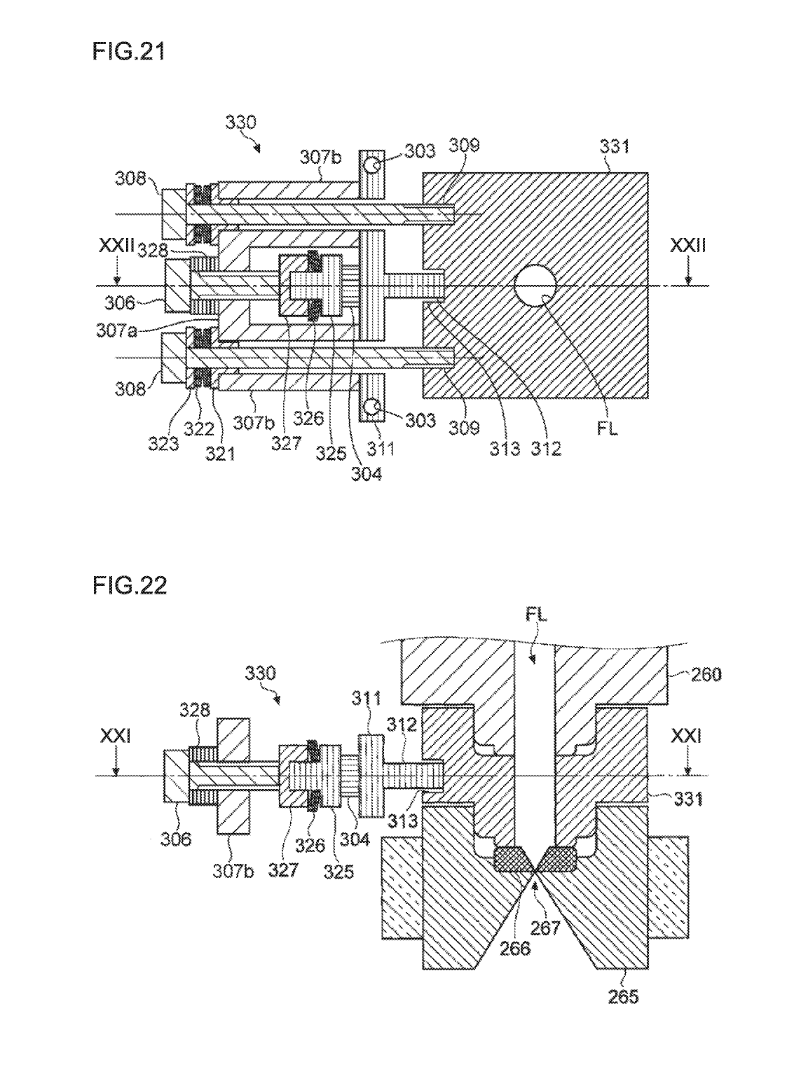

FIGS. 21 and 22 are cross-sectional views illustrating an exemplary mounting of a vibrator unit according to the fifth embodiment. FIG. 21 illustrates an exemplary mounting corresponding to FIG. 9 with use of an exemplary structure of a cross section corresponding to FIG. 20. FIG. 22 is a cross-sectional view of the exemplary mounting illustrated in FIG. 21. It should be noted that FIG. 21 illustrates an example of a cross-sectional structure of a plane XXI-XXI illustrated in FIG. 22, and FIG. 22 illustrates an example of a cross-sectional structure of a plane XXII-XXII illustrated in FIG. 21. In the below description, the same configurations as the configurations illustrated in FIGS. 9, 10, and 20 are denoted by the same reference numerals and the description thereof is not repeated.

As illustrated in FIGS. 21 and 22, the configuration of the vibration transmission member 331 according to the fifth embodiment may be the same as that of the third embodiment.

The configuration of the vibrator unit 330 according to the fifth embodiment may be the same as that of the vibrator unit 330 according to the fourth embodiment.

This means that the shim 328 may be interposed between the beam member 307a of the pressurizing frame 307 and the head of the second bolt 306. It should be noted that even in the vibrator unit 330 of the fifth embodiment, the shim 324 may not be omitted, similar to the case of the fourth embodiment.

The vibrator unit 330 of the fifth embodiment may be mounted on the vibration transmission member 331 in the same manner as that of the third embodiment.

12.2 Operation

Operation of the configuration illustrated in FIGS. 21 and 22 may be the same as that of the third embodiment and the fourth embodiment.

This means that in the vibrator unit 330 of the fifth embodiment, preload to the second elastic member 306 may be adjusted by adjusting the thickness or the number of pieces of the shims 328 as in the case of the fourth embodiment.

Further, the vibration generated in the piezo element 304 may be transmitted from the vibrator pin 312 to the target material 271 in the target flow path FL via the vibration transmission member 331, which is the same as the case of the third embodiment.

12.3 Effect

In the configuration of the fifth embodiment, the same effects as those of the third and fourth embodiments can be achieved.

This means that in the vibrator unit 330 of the fifth embodiment, as pressurization to the piezo element 304 can be adjusted with high accuracy as in the case of the fourth embodiment, transmission efficiency of vibration generated in the piezo element 304 can be improved.

Further, in the configuration of the fifth embodiment, as vibration generated in the piezo element 304 can be directly transmitted to the vibration transmission member 331 in direct contact with the target material 271, the vibration can be transmitted to the target material 271 more efficiently.

Other configurations, operations, and effects may be the same as the embodiments described above.

Further, the modifications of the vibrator pin and the modifications of the contact form between the vibrator pin and the vibrator hole illustrated in FIGS. 12 to 19 can be applied to the configurations of the fourth embodiment and the fifth embodiment. In that case, the maximum diameter of a portion arranged inside the vibrator hole (recessed shape) of the vibrator pin may be smaller than the diameter of the vibrator hole (recessed shape), as in the case of the first to third embodiments and the modifications of the vibrator pin and the modifications of the contact form between the vibrator pin and the vibrator hole.

The above description is intended to provide examples without any limitation. Accordingly, it is obvious to those skilled in the art that changes can be made to the embodiments of the present disclosure without deviating from the scope of the accompanying claims.

The terms used in the present description and in the accompanying claims should be construed as “unlimited” terms. For example, a term “include” or “included” should be construed as “not limited to that described to be included”. A term “have” should be construed as “not limited to that described to be had”. Further, in the present description and the accompanying claims, it should be construed that the indefinite article “a” means “at least one” or “one or more”.

What is claimed is:

1. A vibrator unit configured to apply vibration to a target material supplied to an inside of a target flow path, the vibrator unit comprising:
a vibration transmission member configured to be brought into contact with a first member including the target flow path therein; and
a piezoelectric member to be brought into contact with the vibration transmission member, the piezoelectric member being configured to vibrate in response to an electric signal from an outside,
a vibration dumping rate of the vibration transmission member being smaller than a vibration dumping rate of the first member.

2. The vibrator unit according to claim 1, further comprising:
a first elastic member configured to apply pressure to press the piezoelectric member to the vibration transmission member; and
an adjusting member configured to adjust the pressure applied to the piezoelectric member by the first elastic member.

3. The vibrator unit according to claim 2, wherein
the first elastic member includes a disc spring, and
the adjusting member includes a bolt configured to allow the first elastic member to be interposed between the adjusting member and the piezoelectric member.

4. The vibrator unit according to claim 1, wherein
the vibration transmission member includes a vibrator pin configured to be brought into contact with the first member, and
a diameter of at least a tip of the vibrator pin is contracted.

5. The vibrator unit according to claim 4, wherein
at least the tip of the vibrator pin is in a tapered shape or a protruded spherical shape.

6. A target supply device comprising:
a first member including a target flow path therein; and
a vibrator unit including a vibration transmission member configured to be brought into contact with the first member and a piezoelectric member configured to be brought into contact with the vibration transmission member, the piezoelectric member being configured to vibrate in response to an electric signal from an outside,
a vibration dumping rate of the vibration transmission member being smaller than a vibration dumping rate of the first member.

7. The target supply device according to claim 6, wherein
a contact position with the vibration transmission member in the first member has a recessed shape formed to allow the contact position to approach the target flow path.

8. The target supply device according to claim 7, wherein
the vibration transmission member includes a vibrator pin configured to be brought into contact with the first member,
at least a tip of the vibrator pin is arranged inside the recessed shape, and
a maximum diameter of a portion, arranged inside the recessed shape, of the vibrator pin is smaller than a diameter of the recessed shape.

9. The target supply device according to claim 6, further comprising
a second member configured to store a target material configured to be supplied to the target flow path, wherein
a contact area between the first member and the target material is smaller than a contact area between the second member and the target material.

10. The target supply device according to claim 6, wherein
a minimum distance from a contact position between the first member and the vibration transmission member to the target flow path is 2 mm or greater but 5 mm or less.

11. The target supply device according to claim 8, wherein the first member is a tank portion configured to store a target material.

12. The target supply device according to claim 8, wherein the first member is a nozzle holder configured to hold a nozzle member configured to output a target material passing through the target flow path.

13. The target supply device according to claim 9, wherein
a vibration dumping rate of the vibration transmission member is smaller than a vibration dumping rate of the second member, and
a vibration dumping rate of the first member is smaller than the vibration dumping rate of the second member.

14. The target supply device according to claim 9, further comprising
a third member configured to hold a nozzle member configured to output the target material passing through the target flow path, wherein
the first member is arranged between the second member and the third member, and forms the target flow path from the second member to the third member.

15. The target supply device according to claim 8, wherein
at least a portion of a bottom face of the recessed shape is in a recessed curved face shape.

16. The target supply device according to claim 15, wherein
at least a tip of the vibrator pin is in a protruded spherical face shape, and
the recessed curved face shape is closer to a plane face than the protruded spherical face shape.

17. The target supply device according to claim 8, wherein
a bottom face of the recessed shape includes a positioning part for positioning the vibrator pin with respect to the recessed shape.
